(19) United States
(12) Patent Application Publication
(10) Pub. No.: US 2011/0230619 A1
(43) Pub. Date: Sep. 22, 2011

(54) Nitrogen-Containing Organosilicon Graft Copolymers

(75) Inventors: Dirk Kuppert, Aschaffenburg (DE); Michael Ferenz, Essen (DE); Peter Schwab, Essen (DE); Wilfried Knott, Essen (DE); Stefan Silber, Krefeld (DE)

(73) Assignee: EVONIK GOLDSCHMIDT GMBH, Essen (DE)

(21) Appl. No.: 13/031,324

(22) Filed: Feb. 21, 2011

(30) Foreign Application Priority Data
Feb. 22, 2010 (DE) 102010003180.6

(51) Int. Cl. C08F 283/12

(52) U.S. Cl. 525/100

(57) ABSTRACT

Nitrogen-containing organosilicon graft copolymers of polyalkylene oxide containing siloxane derivatives and their use.

Any foregoing applications including German patent application DE 10 2010 003180.6, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to nitrogen-containing organosilicon graft copolymers obtainable by a free-radical grafting step involving at least one ethylenically unsaturated monomer, wherein at least one monomer contains at least one quaternizable or quaternary nitrogen-containing functionality, in the presence of polyalkylene oxide containing siloxane derivatives, wherein the polyalkylene oxide containing siloxane derivatives themselves are free of ethylenic double bonds, and to their use.

The use of the organosilicon graft copolymers according to the invention comprises the treatment of textile fibres, the use of these polymers as softeners for wovens, nonwovens and/or fibres composed of natural and/or synthetic raw materials, the use of these polymers in compositions for washing fabrics, more particularly for washing and cleaning textiles, the cleaning and reconditioning of hard surfaces, the use for built-structure water-repellent treatment, as a flow control and/or wetting agent in coatings and paints, as a release agent and in cosmetic formulations.

The invention further relates to the use of compositions comprising the graft copolymers.

Industrially made silicones have in recent decades evolved into a significant and diverse group of products, which plays an important part in almost all industrial sectors and is notable for continuous growth. Organomodified silicones in particular, by offering diverse possibilities of engineered variation, have contributed to the creation of a large variety of types of products and hence to opening up a multiplicity of applications.

Owing to their immense economic significance, a number of methods have been developed for preparing such organomodified siloxanes. Linking free-radical polymerization and silicone chemistry for this purpose is desirable from many aspects. The advantages of free-radical polymerization reside in the multiplicity of monomers which can be used and are also available on an industrial scale, in the high tolerance in respect of functional groups, including carboxyl, hydroxyl, amino and epoxy functions, in the relatively low experimental inconvenience, and the mild and also robust reaction conditions. However, the direct grafting of organic olefins onto dialkylsiloxanes—disclosure in the literature notwithstanding—is very disadvantageous both thermodynamically and because of poor compatibilities, and leads predominantly to the formation of homopolymers without chemical bonding to the siloxane backbone.

However, polylether-modified silicones are very useful as grafting base, since the ether groups of the polyether scaffold are appreciably more vulnerable to attack by free radicals. Thus, subjecting polyalkylene oxide containing siloxane derivatives to hydrogen abstraction can be used to create free radicals from which, by addition onto appropriate vinylic monomers, a polymer chain can be grafted. This is described in DE-A-1 645 569 (U.S. Pat. No. 3,471,588) for comb-type structures. DE-A-1 645 569 discloses the use of these graft polymers as stabilizers for polyurethane foams only.

Polysiloxanes having quaternary amino groups and their use as textile softeners are known from the patent literature. For instance, DE-B 14 93 384 (U.S. Pat. No. 3,389,160) describes structures wherein siloxanes are laterally modified by ammonium groups. They are prepared by silicon hydrogen compounds being reacted with an olefin epoxide in the presence of a platinum catalyst to form an epoxidized silicon compound, which is reacted with a secondary amine in the presence of an alcoholic solvent.

Patent document EP 0 282 720 (U.S. Pat. No. 4,833,225) describes structures wherein the quaternary functions are attached to the siloxane terminally. Compounds of this type offer advantages in respect of their performance as textile softeners. They lead to a very pleasant handle on textiles. This is attributable to the unmodified siloxane backbone. Preparation involves reacting terminally epoxy-modified siloxanes with diamines.

The disadvantage of the structures described in patent document EP 0 282 720 is that the maximum degree of modification is two. When a textile is treated with compounds of this type, it does acquire a good soft handle, but the substantivity of the siloxane is so poor that it is readily removed back off the corresponding textile, for example by washing operations. However, it is desirable that the siloxane shall remain on the textile after washing and hence the softness is not lost.

DE-A 33 40 708 (U.S. Pat. No. 4,587,321) discloses polyquaternary polysiloxane polymers. Polyquaternary polysiloxane polymers of this type are free of the disadvantages described above.

However, what militates against the practical use of these compounds is their costly and inconvenient method of preparation. The compounds are only obtainable in economically unacceptable yields of 60% of theory.

WO 02/31256 (U.S. Pat. No. 6,942,818) discloses polyorganosiloxanes having at least one quaternary group comprising at least one nitrogen atom and at least one further polar unit. WO 02/31256 further discloses the use of aqueous dispersions of such polyorganosiloxanes for treatment of fibres. The polyorganosiloxanes are obtained by known reactions via equilibration of suitable starting materials. What is disadvantageous about the synthesis is that the last step of the synthesis always has to be the quaternization of one or more nitrogen atoms.

Softener formulations based on polysiloxane polymers of the prior art further share the trait that a single wash of a textile finished therewith is sufficient to ensure very substantial loss of the softening property.

A desirable combination of properties for the treatment of textile fibres is very good hydrophilic softness combined with enhanced durability on textiles. In addition, a high rebound elasticity and improved crease recovery on the part of a fabric thus finished are desirable as further positive properties.

A further important field of use for quaternary polysiloxane polymers is cleaning and reconditioning hard surfaces in the private and industrial/institutional sector.

These processes require partly complex formulations and predetermined set operating sequences. The washing of vehicles in car washes, for instance, generally consists of a plurality of successive operations which have to be carefully harmonized with each other. This includes the correct choice of chemical formulations, the observance of treatment times, the agitation involved in the cleaning and the choice of temperature; see also F. Müller, J. Peggau, S. Arif, Special Purpose Cleaning Formulations: Auto Care, in Handbook of Detergents, Part D: Formulation, M. Showell, ed. CRC Press, Boca Raton 2006, pp. 261-278.

The actual cleaning, which is subdivided into a preliminary wash and a main wash and which can consist of various base formulations, involves the removal of solid, insoluble particles of soil on the vehicle surface. There are a large number of formulations for this, for the various cleaning methods. These formulations normally consist of anionic surfactant systems which together with basic or acidic components supply the necessary surfactant activity for the cleaning.

This cleaning is followed by the rinsing operation in which cleaning agent residues have to be removed. This step serves as preparation for the application of a suitable drying agent which, prior to the final blow drying, is able to render the vehicle water repellent and thus make it easier to remove the remaining film of water. Rinsing is important because drying agents have a cationic character and otherwise, after the use of anionic cleaning formulations, sparingly soluble salts would form and lead to unsightly spots on the vehicle and thus neither to the desired shine effect nor to water repellency.

Cationic surfactants form the essential ingredients of these formulations in applications requiring substantivity, i.e. permanence of the surface-active compound on the treated good. As in the case of applications in the sector of final rinse fabric conditioners or textile finishing, this class of compounds is also used in drier applications in car washes.

Since vehicle paintwork, like most surfaces, has a negative electric potential, the sprayed application of the drying agent formulation is followed by the cationic surfactants spreading out on the vehicle and displacing the existing film of water. This process, which is referred to as “waterbreak”, results in the film of water associating into droplets. These droplets then run off the vehicle downwards both under their own gravitational force and as a result of the use of a blower in the last step of the car cleaning.

The formulation of drying aids for automatic vehicle cleaning confronts the formulator with particular problems. Thus, the formulation must produce not only a spontaneous waterbreak but also lead to rapid drying and a long-lasting shine. What is important here is the correct in-use concentration, which should be about 0.1% to 0.3%. If the concentration is too low, the film of water will not break; if the concentration is too high, a smeary, greasy layer will form on the vehicle surface and can no longer lead to the desired shiny effect.

The formulation shall remain clear and free of any precipitates even at low temperatures. In addition, the product has to have high water hardness tolerance in order to avoid leading to cloudiness both in hard and soft water and in recycled water. Any applied waxes, oils or other, water-immiscible care compositions which are intended to remain on the surface must be emulsified.

A base formulation for a drier consists generally of quaternary ammonium compounds, so-called quats. The quats used today are almost exclusively environmentally friendly ester quats or imidazoline quats wherein the fatty chain consists mainly of oleic acid. Since quats are usually not soluble in water, these highly unsaturated fatty chains facilitate the formulation in aqueous systems.

In addition to quats, there is a need for raw materials having emulsifying properties in order that the abovementioned profile of requirements may be ensured.

In the course of speeding the operation of car washes, various attempts have been made to speed the relatively slow waterbreak process. For instance, silicone compounds of the quaternary type as described in DE 101 07 772 were tested, albeit without success. Since drier run-off is one of the rate-determining steps in a car wash, speeding will increase the throughput of vehicles in the car wash and hence reduce customer waiting times and enhance plant efficiency.

WO 99/04750 (U.S. Pat. No. 6,403,074) discloses the use in cosmetic formulations of polymers which are water soluble or water dispersible or which, when consisting of monomers having neutralizable radicals, are water soluble or water dispersible in the neutralized form, and which are obtainable by free-radically polymerizing (a) ethylenically unsaturated monomers in the presence of (b) polyalkylene oxide containing silicone derivatives.

Citation or identification of any document in this application is not an admission that such document is available as prior art to the present invention.

There is accordingly a need for nitrogen-containing polysiloxane polymers and more particularly for such polysiloxane polymers with quaternary amino groups that are obtainable in high yields, can be used for many different purposes and also have improved properties over the polymers of the prior art, or do not have the one or more disadvantages of the prior art. More particularly, they should also be obtainable by an economical process which does not lead to the formation of inutile by-products (e.g.: coagulum in an emulsion polymerization).

The present invention accordingly has for its object to provide nitrogen-containing polysiloxane polymers and more particularly such polysiloxane polymers with quaternary ammonium groups that no longer have one or more disadvantages of the prior art.

It has now been found that, surprisingly, this object is achieved by the use of nitrogen-containing organosilicon graft copolymers obtainable by a free-radical grafting step involving at least one ethylenically unsaturated monomer, wherein at least one monomer contains at least one quaternizable or quaternary nitrogen-containing functionality, in the presence of polyalkylene oxide containing siloxane derivatives free of ethylenically unsaturated groups in a particular manner, whereby free of ethylenically unsaturated groups means not being analytically detectable.

The present invention accordingly provides nitrogen-containing organosilicon graft copolymers obtained by a free-radical grafting step involving at least one ethylenically unsaturated monomer, wherein at least one monomer contains at least one quaternizable or quaternary nitrogen-containing functionality, in the presence of polyalkylene oxide containing siloxane derivatives free of ethylenically unsaturated groups.

The quaternizable or quaternary nitrogen-containing functionality may be a cyclic or acyclic amine functionality.

The invention further provides a process for preparing these graft copolymers and also their use.

Particularly suitable products for achieving the object are organosilicon graft copolymers bearing at least one permanently quaternary, i.e. positively charged nitrogen functionality.

Of very particular suitability for achieving the objects are organosilicon graft copolymers having at least one permanently quaternary nitrogen functionality and obtainable by the free-radical graft polymerization of at least one ethylenically unsaturated monomer having at least one quaternary nitrogen-containing functionality in the presence of polyalkylene oxide containing siloxane derivatives.

The nitrogen-containing organosilicon graft copolymers are useful for a wide variety of, for example the above-recited, applications, wherein organically modified polyether siloxanes are used.

The polyalkylene-containing siloxanes useful as grafting base in the presence of which the free-radical reaction takes place are selected from polyether siloxanes of formula (I),

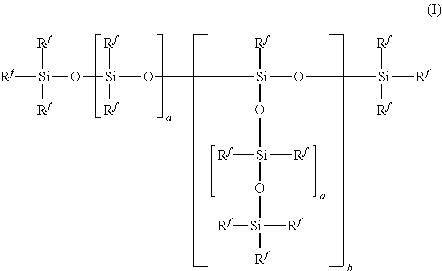

where
b is a number from 0 to 10, preferably <5 and more preferably 0,
a is a number from 1 to 500, preferably from 1 to 250 and more preferably from 1 to 100,
R^{f} in each occurrence is the same or different R¹ or R² provided that at least one R^{f} is R²,
R¹ represents organic radicals selected from linear or branched alkyl, haloalkyl, aryl, alkylaryl or arylalkyl radicals of 1 to 30 carbon atoms, preferably 2 to 6 carbon atoms, preferably phenyl in the case of aryl radicals, wherein the radicals may optionally be interrupted by one or more oxygen and/or nitrogen atoms and/or may optionally have an —OC(O)CH₂ group at the end of the radical,
R² represents a group of the formula A_{α}-B_{β}—K_{χ}D_{δ}-E_{ε}-L_{λ}, where
α is 1,
β, χ, δ and ε is 0 or 1,
λ is 1 and
α+β+χ is ≧1, wherein
A is an oxygen atom or a CH₂ group,
B is a group of the general formula (II)

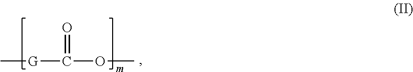

where
m is an integer from 0 to 30 and
G may be a divalent group selected from linear or branched, saturated alkyl, aryl, alkylaryl or arylalkyl groups of 1 to 20 carbon atoms,
K is a —CH₂— group or a divalent radical selected from linear or branched, saturated alkyl, aryl, alkylaryl or arylalkyl oxy groups of 1 to 20 carbon atoms or a group of the formula —CH₂—O—(CH₂)₄—O—,
D is a group of the general formula (III)

(C₂H₄O)ₙ(C₃H₆O)ₚ(C₁₂H₂₄O)_{q}(C₈H₈O)ᵣ(C₄H₈O)ₛ— (III)
where the indices n, p, q, r and s are mutually independent integers from 0 to 100,
and where the sum total of n, p, q, r and s is 1, preferably from 2 to 250, more preferably from 5 to 150 and even more preferably from 10 to 80, and when more than one of the indices n, p, q, r, s is >0, the general formula (III) may be a random oligomer or a block oligomer. R² is preferably a polyether radical of formula (III) where n and/or p are each 3, preferably in the range from 3 to 100 and more preferably in the range from 5 to 50. R² is more preferably a polyether radical of formula (III) where n and p are each 3, preferably in the range from 3 to 100 and more preferably in the range from 5 to 80, and q and/or r, s is 0, preferably q, r and s is 0,
E is a group of the general formula (IV)

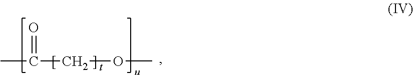

where
u is an integer from 0 to 5 and
t, when u is >0, may be the same or different and represents 3, 4 or 5, and
L is selected from the group comprising hydrogen atoms, linear or branched, saturated alkyl, aryl, alkylaryl or arylalkyl groups of 1 to 12 carbon atoms, preferably of 1 to 10, or acetoxy groups.

Particular preference is given to polyether siloxanes of formula (I) where A=—CH₂—, α=1, β=0, χ=1. Very particular preference is given to polyether siloxanes of formula (I) where A=—CH₂—, α=1, β=0, χ=1 and K=—CH₂—CH₂—O—.

The polyether siloxanes obtained may be straight-chain (b=0) or branched (0<b≦10). The values of a and b are to be understood as average values, since the polysiloxanes used can be present not just as a pure material but also in the form of equilibrated mixtures.

A person skilled in the art knows that the compounds, owing to their polymeric nature, are present in the form of a mixture having a distribution that is substantially governed by statistical laws. The values of all indices are accordingly mean values. Preference is given to using such equilibrated mixtures of poly(ether)siloxanes.

These ethylenically unsaturated polyether siloxanes are obtainable for the case where A in formula (I) is not oxygen in a conventional manner by hydrosilylating hydrosiloxanes of the general formula (V) with alkenyl polyethers in the presence of platinum or rhodium catalysts, as described in EP-A-0 659 803 (U.S. Pat. No. 5,486,634) for example.

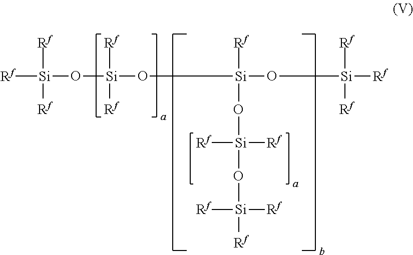

In formula (V) a, b, and R^{f} are each as defined in formula (I) except that R²═H.

Preference is given to using alkenyl polyethers selected from alkenyl polyethers of formula (VI)

CH₂═CR³-Q-(C₂H₄O)ₙ(C₃H₆O)ₚ(C₁₂H₂₄O)_{q}(C₈H₈O)ᵣ(C₄H₈O)ₛL (VI)

where
R³ is H or methyl,
Q is a divalent optionally branched hydrocarbyl radical of 1 to 18 carbons, preferably 1 to 4 carbon atoms and more preferably one carbon atom,
L is an H atom or a monovalent linear or branched organic radical such as alkyl, aryl, alkylaryl, arylalkyl or acetoxy, preferably of 1 to 20 and more preferably of 1 to 10 carbons, the indices
n, p, q, r and are mutually independent integers from 0 to 100, the sum total of
n, p, q, r and s is 1 and when more than one of the indices n, p, q, r, s is >0, the general formula (IV) may be a random oligomer or a block oligomer.

The sum total of n, p, q, r and s is preferably in the range from 2 to 250, more preferably in the range from 5 to 150 and even more preferably in the range from 10 to 80. Preference is given to such alkenyl polyethers (VI) where n and/or p are each 3, preferably in the range from 3 to 100 and more preferably in the range from 5 to 50. Particular preference is given to such alkenyl polyethers (VI) where n and p are each 3, preferably in the range from 3 to 100 and more preferably in the range from 5 to 80, and

q and/or r and/or s is 0, preferably q and r and s=0.

The polyethers described by formula (VI) are obtainable for example from a starting alcohol having an alpha-disposed carbon-carbon double bond by addition of monomers onto the double bond. Suitable monomers are ethylene oxide, propylene oxide, compounds from the group consisting of tetrahydrofuran, 1,2-epoxybutane, 2,3-epoxybutane, dodecyl oxide, styrene oxide and/or methylstyrene oxide and mixtures thereof. The distribution of the monomers may be chosen in any desired manner, so that a random oligomer or a block polymer may be obtained.

The preparation of polyether siloxanes according to formula (I) where A is an oxygen is likewise obtainable in a conventional manner by dehydrogenative condensation of hydroxyl-terminated polyethers with hydrosiloxanes.

The dehydrogenative condensation is preferably carried out in the presence of a catalyst. Suitable catalysts for the dehydrogenative condensation are for example NaOH, KOH, tetramethylammonium hydroxide, alkali metal fluorides, alkaline earth metal fluorides, boron catalysts such as tris(pentafluorophenyl)borane, carboxylic acids and/or carboxylates or mixtures thereof. The catalytic dehydrogenative condensation is described for example in the documents EP-A-1 460 098 (U.S. Pat. No. 7,053,166), DE-A-103 12 636 (US Publ. 2004-186260) and DE-A-103 59 764 (US Publ. 2005-136269).

Silicone derivatives useful as grafting base further include the compounds known and commercially available under the INCI names Dimethicone Copolyols or Silicone Surfactants, for example the compounds traded under the brand names Abil® or Tegopren® of Evonik Goldschmidt GmbH.

Monomers polymerizable using a reaction initiated by free radicals are preferred. The term ethylenically unsaturated is to be understood as meaning that the monomers have at least one polymerizable carbon-carbon double bond, which may be mono-, di-, tri- or tetrasubstituted.

Any monomeric ethylenically unsaturated compound and any polymeric olefin with at least one residue of unsaturatedness (such as polymers of butadiene or of isoprene or any type of macromonomers, including those which contain siloxane chains) and has at least one nitrogen-containing functionality which can be quaternized can be used in the graft polymerization to prepare the graft copolymers of the invention.

The monomers mentioned, which have at least one nitrogen-containing functionality which can be quaternized, can also be graft polymerized in mixtures with nitrogen-free monomers.

Very particular preference is given to using any monomeric ethylenically unsaturated compound and any polymeric olefin having at least one residue of unsaturatedness (such as polymers of butadiene or of isoprene or any type of macromonomers, including those which contain siloxane chains) and having at least one quaternary nitrogen-containing functionality in the graft polymerization for preparing the graft copolymers of the invention.

Ethylenically unsaturated monomers may preferably be used as suitable polymerizable monomers. Either a single monomer or combinations of two or more monomers can be used provided at least one monomer has a nitrogen-containing functionality which can be quaternized. Polymerizable is to be understood as meaning that the monomers used can be polymerized using any conventional synthetic method.

In addition to at least one monomer having at least one nitrogen-containing functionality, nitrogen-free compounds can also be used in the grafting step which are described by the following general formula (VII):

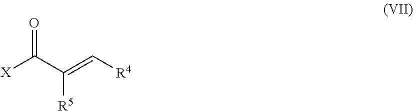

where R⁵ and R⁴ are independently selected from the group containing —H, C₁-C₈ linear- or branched-chained alkyl chains, methoxy, ethoxy, 2-hydroxyethoxy, 2-methoxyethoxy and 2-ethoxyethyl,
X is selected from the group of the radicals —OH, —OM, —OR⁶, where the R⁶ radical may be selected from the group consisting of —H, C₁-C₄₀ linear- or branched-chained alkyl radicals, 2-hydroxyethyl, 2-methoxyethyl, 2-ethoxyethyl, hydroxypropyl, methoxypropyl or ethoxypropyl.
M is a cation selected from the group consisting of: Na⁺, K⁺, Mg⁺⁺, Ca⁺⁺, Zn⁺⁺, NH₄⁺, alkylammonium, dialkylammonium, trialkylammonium and tetraalkylammonium.

Representative but nonlimiting examples of suitable monomers are for example acrylic acid and its salts, esters and amides. The salts can be derived from any desired nontoxic metal, ammonium or substituted ammonium counter-ions.

The esters can be derived from C₁-C₄₀ linear, C₃-C₄₀ branched-chain or C₃-C₄₀ carbocyclic alcohols, from multiply functional alcohols having 2 to about 8 hydroxyl groups such as ethylene glycol, hexylene glycol, glycerol and 1,2,6-hexanetriol, from amino alcohols or from alcohol ethers such as methoxyethanol, ethoxyethanol or polyalkylene glycols, such as polyethylene glycols for example.

Useful monomers further include substituted acrylic acids and also salts, esters and amides thereof, wherein the substituents are positioned on the carbon atoms in positions two and three of the acrylic acid, and are each independently selected from the group consisting of C₁-C₄ alkyl, —CN, COOH, more preferably methacrylic acid, ethacrylic acid and 3-cyanoacrylic acid. These salts, esters and amides of these substituted acrylic acids can be selected as described above for the salts, esters and amides of acrylic acid.

Other suitable monomers are vinyl and allyl esters of C₁-C₄₀ linear, C₃-C₄₀ branched-chain or C₃-C₄₀ carbocyclic carboxylic acids (e.g.: vinyl acetate, vinyl propionate, vinyl neononanoate, vinyl neoundecanoic acid or vinyl t-butyl-benzoate); vinyl or allyl halides, preferably vinyl chloride and allyl chloride, vinyl ethers, preferably methyl, ethyl, butyl or dodecyl vinyl ether, vinylformamide, vinylmethylacetamide, vinylamine; vinyllactams, preferably vinylpyrrolidone and vinylcaprolactam, vinyl- or allyl-substituted heterocyclic compounds, preferably vinylpyridine, vinyloxazoline and allylpyridine.

Additionally suitable and co-usable nitrogen-free monomers are vinylidene chloride; and hydrocarbons having at least one carbon-carbon double bond, preferably styrene, alpha-methylstyrene, tert-butylstyrene, butadiene, isoprene, cyclohexadiene, ethylene, propylene, 1-butene, 2-butene, isobutylene, vinyltoluene, and also mixtures thereof.

Useful monomers in addition to the monomers mentioned above include so-called macromonomers such as for example silicone-containing macromonomers having one or more free-radically polymerizable groups or alkyloxazoline macromonomers as described for example in EP 408 311 (U.S. Pat. No. 5,166,276).

It is further possible to use fluorine-containing monomers as described for example in EP 558 423, and also crosslinking or molecular weight regulating compounds, in combination or alone.

Preference for use as nitrogen-containing monomers is given to N,N-dialkylaminoalkyl acrylates and methacrylates and N-dialkylaminoalkylacrylamides and -methacrylamides of the general formula (VIII)

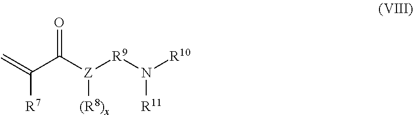

where R⁷=H, alkyl of 1 to 8 carbon atoms, R⁹=H, methyl, R⁹=alkylene of 1 to 24 carbon atoms, optionally substituted by alkyl, R¹⁰ and R¹¹ are each independently C₁-C₄₀ alkyl, Z=nitrogen for x=1 and oxygen for x=0. The amides may be unsubstituted, N-alkyl or N-alkylamino monosubstituted or N,N-dialkyl substituted or N,N-dialkylamino disubstituted, wherein the alkyl or alkylamino groups are derived from C₁-C₄₀ linear, C₃-C₄₀ branched-chain or C₃-C₄₀ carbocyclic units. The alkylamino groups can additionally be quaternized.

Particularly preferred monomers of formula (VIII) are N,N-dimethylaminomethyl (meth)acrylate, N,N-diethylaminomethyl (meth)acrylate, N,N-dimethylaminoethyl(meth)acrylamide, N,N-diethylaminoethyl(meth)acrylamide, N,N-dimethylaminopropyl (meth)acrylate, N,N-diethylaminopropyl(meth)acrylate, N,N-dimethylaminopropyl(meth)acrylamide, N,N-diethylamino-propyl(meth)acrylamide.

Suitable nitrogen-containing monomers further include N-vinylimidazoles of the general formula (IX):

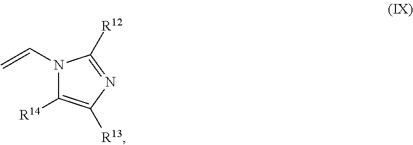

wherein R¹² to R¹⁴ are each independently hydrogen, C₁-C₄-alkyl or phenyl.

Suitable nitrogen-containing monomers further include diallylamines of the general formula (X)

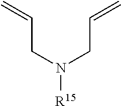

where R¹⁵=C₁ to C₂₄ alkyl.

Monomers having a basic nitrogen atom can be quaternized as follows: Amines are suitably quaternized using for example alkyl halides having 1 to 24 carbon atoms in the alkyl group, for example methyl chloride, methyl bromide, methyl iodide, ethyl chloride, ethyl bromide, propyl chloride, hexyl chloride, dodecyl chloride, lauryl chloride and benzyl halides, more particularly benzyl chloride and benzyl bromide.

Further suitable quaternizing agents are dialkyl sulphates, more particularly dimethyl sulphate or diethyl sulphate. The quaternization of the basic amines can also be achieved with alkylene oxides, such as ethylene oxide for example, in the presence of Brönsted acids.

Preferred quaternizing agents are: methyl chloride, dimethyl sulphate or diethyl sulphate.

Particular preference is given to using monomers already having at least one quaternary nitrogen-containing group, more particularly monomers of the general formula (XI)

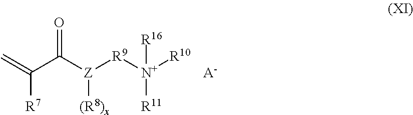

where R⁷, R⁸, R⁹, R¹⁰, R¹¹, Z and x are each as defined in formula (VIII), R¹⁶=C₁-C₄₀ alkyl and A⁻ is a suitable negatively charged anion, for example fluoride, chloride, bromide, iodide, alkylsulphates, for example methylsulphate or ethylsulphate, sulphate, hydrogensulphate, methanesulphonate and trifluoromethanesulphonate. Particular preference among these is given to chloride, methylsulphate and ethylsulphate. Chloride is very particularly preferred.

Monomers of formula (XI) which are used with particular preference are 2-trimethylammonioethyl methacrylate chloride, 2-trimethylammoniomethyl acrylate chloride, 2-triethylammonio-ethyl methacrylate chloride, 2-triethylammonioethyl acrylate chloride, 3-trimethylammoniopropylmethacrylamide chloride, 3-trimethylammoniopropylacrylamide chloride, 3-triethylammonio-propylmethacrylamide chloride and 3-triethylammonio-propylacrylamide chloride.

The quaternization can be carried out before the polymerization or after the polymerization. The quaternization is preferably carried out before the polymerization. Very particular preference is given to using monomers having at least one quaternary nitrogen-containing functional group as disclosed in formula (XI).

It is also possible to use the reaction products of unsaturated acids, for example acrylic acid or methacrylic acid, with a quaternized epichlorohydrin of the general formula (XII) where R¹⁷=C₁ to C₄₀ alkyl and A⁻ is a suitable negatively charged anion, for example fluoride, chloride, bromide, iodide, alkylsulphates, for example methylsulphate or ethylsulphate, sulphate, hydrogensulphate, methanesulphonate and trifluoromethanesulphonate. Particular preference among these is given to chloride, methylsulphate and ethylsulphate. Chloride is very particularly preferred.

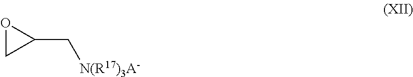

Examples thereof are for example: (meth) acryloyloxyhydroxypropyltrimethylammonium chloride and (meth) acryloyloxyhydroxypropyltriethylammonium chloride.

The basic monomers may also be cationized by neutralizing them with mineral acids, for example sulphuric acid, hydrochloric acid, hydrobromic acid, hydroiodic acid, phosphoric acid or nitric acid, or with organic acids, for example formic acid, acetic acid, lactic acid or citric acid.

Any combination of the monomers mentioned can be used in any desired mixing ratios provided at least one monomer has at least one nitrogen-containing functionality. A further desideratum is that the monomers should be compatible. More particularly, combinations can also be chosen in which the monomers have different reactivities and thus produce gradient copolymers.

The regulators used may be the customary compounds known to a person skilled in the art, for example sulphur compounds (e.g.: mercaptoethanol, 2-ethylhexyl thioglycolate, thioglycolic acid or dodecyl mercaptan) and also tribromochloromethane or other compounds which have a regulating effect on the molecular weight of the graft polymers obtained. It is also possible, if desired, to use silicone compounds comprising thiol groups or alkenyl polyethers comprising thiol groups as regulators. However, preference is given to using silicone-free regulators or to adjusting the synthesis conditions such that no regulators need be used.

The ethylenically unsaturated monomers can be reacted in the grafting step free-radically by a compound comprising a polyether group using any conventional synthetic method known to a person skilled in the art.

The grafting step can be performed as solution polymerization, emulsion polymerization, inverse emulsion polymerization, suspension polymerization, inverse suspension polymerization or as precipitation polymerization without the methods which can be used being restricted thereto. The free-radical reaction can be carried out for example as described in DE-1 645 569, incorporated herein by express reference.

The grafting step can be carried out in the presence or absence of solvents. The grafting step can be carried out in a single-, two- or multi-phase system. The only important prerequisite is the mutual solubility of the reactants in the corresponding medium (solvent). The solvent used in the grafting step more particularly in a solution polymerization can be an organic solvent, the polysiloxane (mixture) used or the alkenyl polyether used or water or mixtures thereof.

The grafting step can be carried out under atmospheric pressure, superatmospheric pressure or reduced pressure. The grafting step is carried out with particular preference under atmospheric pressure.

An entity which forms free radicals under the reaction conditions is an essential prerequisite and a constituent part of the grafting step to prepare the graft copolymers. Any agent suitable in principle for producing free radicals can be used, including, but not exclusively, ionizing irradiation, organic peroxy compounds, azo compounds or inorganic free-radical formers, for example inorganic peroxodisulphates. Preference is given to using azo compounds and organic peroxy compounds. In the case of water-containing reaction systems or water as a solvent, very particular preference is given to using alkali metal and ammonium peroxodisulphate as free-radical formers. It is further possible to use redox systems, for example potassium peroxodisulphate and sodium hydrogensulphite, to produce free radicals.

For improved metering or compatibility of the free-radical formers it can be advantageous to use the free-radical formers in the form of solutions thereof in a suitable solvent. Any solvent which does not interfere with the free-radical reaction is suitable. Preference is given to using the solvents mentioned as suitable solvents for the free-radical reaction. When inorganic free-radical formers are used, water is preferably used as solvent for the free-radical formers.

The temperature chosen for the reaction depends on the compounds used to form free radicals. When free-radical formation is induced thermally, the half-life of the disintegration into primary particles plays a decisive part and can be chosen such that a desired ratio of free radicals will always become established in the reaction mixture. Temperatures utilized in thermally induced free-radical formation are preferably in the range from 30° C. to 225° C. and more preferably in the range from 50 to 180° C., the upper limit of the temperature being dictated by the thermal decomposition of the grafting base. When redox systems are used as free-radical formers, it is preferable to utilize temperatures in the range from −30° C. to 50° C.

Crosslinking monomers used can be compounds having at least two ethylenically unsaturated double bonds, for example esters of ethylenically unsaturated carboxylic acids, such as acrylic acid or methacrylic acid and polyhydric alcohols, ethers of at least dihydric alcohols such as for example vinyl ether or allyl ether. Also suitable are straight-chain or branched, linear or cyclic aliphatic or aromatic hydrocarbons which, however, tolerate at least two double bonds which must not be conjugated in the case of aliphatic hydrocarbons. Also suitable are amides of acrylic and methacrylic acid and N-allylamines of at least difunctional amines such as for example (1,2-diaminoethane, 1,3-diaminopropane). Also suitable are triallylamine or corresponding ammonium salts, N-vinyl compounds of urea derivatives, at least difunctional amides, cyanurates or urethanes.

Particularly preferred crosslinkers are for example methylenebisacrylamide, triallylamine and triallylammonium salts, divinylimidazole, N,N′-divinylethyleneurea, reaction products of polyhydric alcohols with acrylic acid or methacrylic acid, methacrylic esters and acrylic esters of polyalkylene oxides or polyhydric alcohols which have been reacted with ethylene oxide and/or propylene oxide and/or epichlorohydrin. As will be familiar to a person skilled in the art, however, the molecular weights can be adjusted such that no crosslinkers are necessary.

The compositions of the invention may include graft copolymers containing any relative amounts of ethylenically unsaturated compounds grafted onto the polyether siloxane as grafting base. Preferred quantitative ratios vary according to use, and generally lie between 1% and 10 000% by weight of the particular underlying grafting base.

The amount of the quaternizable or quaternary monomer used is preferably in the range from 1% to 75% by weight based on the polyether siloxane. A ratio of 1% to 50% by weight is particularly preferred and of 2% to 25% by weight is very particularly preferred. When further nonquaternary or nonquaternizable monomers are used in the free-radical grafting, a ratio of polyether siloxane to nonquaternary or nonquaternizable monomers between 0.1% and 99% by weight is preferred. A ratio of 1% to 75% by weight is particularly preferred and of 1% to 50% by weight is very particularly preferred, irrespective of the ratio of the quaternizable or quaternary monomer and of the polyether siloxane.

Preferred compositions include such graft copolymers as are obtainable by a free-radical grafting step in the presence of polyalkylene oxide containing siloxane derivatives with at least one ethylenically unsaturated monomer comprising a nitrogen-containing functionality.

The polyalkylene oxide containing siloxane derivative is preferably free of ethylenically unsaturated groups.

Very particularly preferred compositions include such graft copolymers as are obtainable by a free-radical grafting step in the presence of polyalkylene oxide containing siloxane derivatives with at least one ethylenically unsaturated monomer, wherein at least one monomer contains at least one quaternized nitrogen-containing functionality.

This invention further provides for the use of the nitrogen-containing organosilicon graft copolymers or compositions as a softener or soft hand agent for wovens, nonwovens and/or fibres composed of natural and/or synthetic raw materials, for textiles, as an additive in cosmetic applications, as a constituent of hair treatment agents in the form of shampoo, hair rinse, conditioner, hair spray and/or as a constituent of hair styling gel.

In addition, the polyalkyene oxide containing siloxane derivatives according to the invention can be used in cleaning agents for cleaning hard surfaces, hard coated or uncoated surfaces of glass, ceramic, plastic or metal, or of ware, domestically and industrially/institutionally, and also in industrial car washing in drying assistants in car washes. Hard surfaces also comprise smooth, rough, profiled or unprofiled tiles, stoneware tiles and flags on, for example, floors and/or walls.

The cleaning agent can be in liquid or solid form. Use can be not only as a manual washing-up agent but also as a dishwasher detergent in the private and/or institutional/industrial sector.

The nitrogen-containing organosilicon graft copolymers according to the invention are likewise suitable for use as active ingredients in cosmetic preparations or personal care compositions, whether they be skin-cosmetic preparations such as liquid soaps, body lotions, aftershaves, facial tonics, deodorants and other cosmetic lotions, or hair-cosmetic preparations, such as hair tonics, hair lotions, hair rinses, hair emulsions, tips fluids, levelling agents for permanent waves, hot oil treatment products, conditioners, setting lotions, hair sprays. They are further useful for hand and body lotions, facial moisturizers, sun cream, anti-acne formulations, anti-ageing formulations, topical analgesics, mascara and the like, the enumeration being exemplary and nonexhaustive. Depending on the field of application, the cosmetic preparations can be applied as spray, foam, gel, gel spray, lotion or mousse.

Additional components needed to formulate such products vary with the type of product and can easily be selected by a person skilled in the art, such as perfume oils, emulsifiers, preservatives, care agents such as panthenol, collagen, vitamins, protein hydrolysates, stabilizers, pH regulators, dyes, solvents, propellant gases and further customary additives known to a person skilled in the art.

Further subjects of the invention will be apparent from the claims, the disclosure content of which fully forms part of the subject matter of this description.

The invention is further described by the following non-limiting examples which further illustrate the invention, and are not intended, nor should they be interpreted to, limit the scope of the invention.

### EXPERIMENTAL EXAMPLES

### Example 1

Preparing a nitrogen-containing organosilicon graft copolymer and subsequent quaternization.

200 g of silicone polyether (Tegopren® 5842, trade name of Evonik Goldschmidt GmbH, CAS No.: 68937-54-2) were heated to 117° C. under nitrogen in a four-neck flask equipped with stirrer, intensive condenser, thermometer and dropping funnel. A solution of 2 g of Trigonox® 117 (trade name of AkzoNobel, chemical name: tert-butyl peroxy-2-ethylhexyl carbonate) in 60 g of dimethylaminoethyl methacrylate was added dropwise to the initially charged silicone polyether during 4 h. The reaction mixture was subsequently maintained at 117° C. for 30 minutes and then cooled down to room temperature.

The reaction product was subsequently dissolved in 260 g of methoxypropanol and heated to 100° C. under nitrogen. 48 g of dimethyl sulphate were added dropwise at 100° C. during 30 minutes. The temperature must not exceed 105° C. in the process. Subsequently, the methoxypropanol was distilled off. The residue is the desired product.

### Example 2

Preparing a nitrogen-containing organosilicon graft copolymer by free-radical reaction with a quaternary monomer:

80 g of silicone polyether (Tegopren® 5842, trade name of Evonik Goldschmidt GmbH, CAS No.: 68937-54-2) and 40 g of ethanol were initially charged to and heated up to 75° C. in a four-neck flask equipped with stirrer, intensive condenser, thermometer and dropping funnel under nitrogen. A mixture of 16 g of a 50% aqueous solution of 3-trimethylammoniopropyl-methacrylamide chloride (CAS No.: 51410-72-1), 0.8 g of 2,2′-azobis(2-amidinopropane) dihydrochloride (trade name: V-50 from Wako Pure Chemical Industries, Ltd.) and 20 g of ethanol was added dropwise to the initially charged silicone polyether during 4 hours. The ethanol is subsequently distilled off to obtain the desired product as a white liquid.

Application examples follow to demonstrate the properties of the invention compounds and, for comparison thereto, properties obtainable with known products of the prior art.

### Application Examples

### A) Soft Handle for Textiles

General formulation:

5% to 50% by weight of a nitrogen-containing organosilicon graft copolymer are initially charged with stirring to a glass beaker equipped with a propeller stirrer. Thereafter, 5% to 25% by weight of dipropylene glycol, 3% to 10% by weight of a fatty alcohol ethoxylate having a degree of ethoxylation of 6 and 3% to 10% by weight of a fatty alcohol ethoxylate having a degree of ethoxylation of 12 are added in succession with stirring. Lastly, the mixture is made up to 100% by weight with water.

Formulations W1 and W2 were prepared from Examples 1 and 2 similarly to the preparation of the general formulation.

### Formulation W3

### Comparative Example

A commercially available microemulsion of an amino-functionalized siloxane, for example TEGOSIVIN® IE 11/59 having a solids content of 20% by weight.

### Formulation W4

### Comparative Example

A commercially available emulsion of an organic softener, for example REWOQUAT® WE 18 having a solids content of 15% by weight.

To verify the handle and also the hydrophilicity of the present invention, products consisting of native fibres were finished using the following process:

### Padding Process:

To examine the softness conferred by each emulsion, knit cotton fabric (160 g/m²) and terry cotton fabric (400 g/m²) were padded with a liquor containing in each case 20 g/l of the corresponding emulsion, squeezed off to a wet pick-up of about 100% and dried at 130° C. for three minutes.

To examine the hydrophilicity, woven cotton fabric (200 g/m²) was padded with a liquor containing in each case 50 g/l of the corresponding emulsion and squeezed off to a wet pick-up of about 100% and dried at 130° C. for three minutes.

### Handle Assessment:

Fabric handle was assessed by an experienced team which assessed the anonymized handle samples, the knit and terry fabrics finished with the emulsions, with the aid of a hand panel test. The handle samples of knit fabric additionally included an untreated sample not overtly labelled.

### Hydrophilicity Testing:

Hydrophilicity testing was performed using an in-house test method for measuring the height of rise of water, in line with German standard specification DIN 53924. The finished woven cotton test fabric is cut into five strips each 25 cm in length and 1.5 cm in width, marked with a water-soluble pen and secured in a taut perpendicular position, but without tension, to a holder. The holder is subsequently placed for five minutes in a water bath such that 2 cm of the strips are in the water. After the holder has stood outside the water bath for 10 minutes, the height of rise is read off in cm and assessed against the blank value (height of rise of untreated cotton strip×cm=100%) and reported as a % age of the blank value.

### Washing Operation:

The washing operations were performed in a commercial washing machine, Miele Novotronic® W 918, with coloureds wash without prewash at 40° C. using IECA base standard laundry detergent and 3 kg of cotton ballast fabric. The fabric thus treated was finally dried at room temperature for 12 hours.

The softness assessment on knit cotton fabric after application by padding was done before the wash after the 1^{st} wash after the 3^{rd} wash and after the 5^{th} wash.

The softness assessment on terry cotton fabric after application by padding was done before the wash after the 1^{st} wash after the 3^{rd} wash and after the 5^{th} wash.

Rewettability on woven cotton fabric was determined before the wash after the 1^{st} wash after the 3^{rd} wash and after the 5^{th} wash.

The result is an improved softness of the fabrics finished with inventive polymers compared with the fabrics finished with prior art products. The pleasant hand substantially survives repeated washing. It can be seen in addition that hydrophilicity, as determined via rewettability, is also preserved throughout repeated washing.

### B) Use in Cosmetics

### Preparation and Testing of Hair Treatment Agents:

For the performance assessment, hair tresses used for sensory tests are predamaged in a standardized manner by means of a permanent wave treatment and a bleaching treatment. For this, products customary in hair dressing are used. The test procedure, the base materials used and also the details of the assessment criteria are described in DE 103 27 871 (US 2004-258651).

### Test Formulations:

For the performance assessment, the inventive compounds and comparative products are used in simple cosmetic formulations. The performance characteristics during use in a shampoo were tested in the following recipe:

| Product | Weight fractions |
|---|---|
| Sodium lauryl ether sulphate (28% | 32 |
| strength) e.g. TEXAPON ® NSO (Cognis) | |
| “Conditioner” | 0.5% |
| TEGO ® Betain F | 10% |
| Cocamidopropyl Betaine (30%) | |
| Cationic polymer to improve the | 0.3% |
| efficacy of conditioners (cationic | |
| deposition polymer) | |
| (e.g. Guar Hydroxypropyl trimonium | |
| Chloride, Polyquaternium-10) | |
| Water | ad. 100% |
| Citric acid | ad. pH 6.0 ± 0.3 |

To assess the properties of the shampoo formulation, the test procedure did not include any aftertreatment with a rinse. In addition, the inventive products were also tested in a simple hair rinse having the following construction:

| Product | Weight fractions |
|---|---|
| TEGINACID ®C | 0.5% |
| Ceteareth-25 | |
| TEGO ®Alkanol 16 | 2.0% |
| Cetyl Alcohol | |
| “Conditioner” | 1.0% |
| VARISOFT ® 300 | 3.3% |
| Cetrimonium Chloride (30%) | |
| Water | ad. 100% |
| Citric acid | ad. pH 4.0 ± 0.3 |

The hairs are pretreated when the properties of hair rinses are to be tested by means of a shampoo which does not contain any conditioner.

The “conditioner” refers to the inventive compound examples, comparative products or combinations of inventive compounds and known conditioners (more particularly Cetrimonium Chloride). The comparative compound used was Quaternium-80 (ABIL® Quat 3272, trade name of Evonik Goldschmidt GmbH).

Standardized Treatment of Predamaged Hair Tresses with Conditioning Samples:

The hair tresses predamaged as described above are treated as follows with the above-described shampoo or the above-described conditioning rinse:

The hair tresses are wetted under warm running water. The excess water is gently squeezed out by hand, then the shampoo is applied and gently worked into the hair (1 ml/hair tress (2 g)). After a residence time of 1 min, the hair is rinsed for 1 min.

Where appropriate, the rinse is directly applied thereafter and gently worked into the hair (1 ml/hair tress (2 g)). After a residence time of 1 min, the hair is rinsed for 1 min.

Prior to the sensory assessment, the hair is air dried at 50% relative humidity and 25° C. for at least 12 h.

The composition of the test formulations is deliberately chosen to be simple to avoid influencing the test results through (normally present) formulation constituents. In addition to and/or instead of the ingredients mentioned, inventive formulations may contain still further ingredients.

### Assessment Criteria:

The sensory assessments are made according to grades awarded on a scale of from 1 to 5, where 1 is the worst assessment and 5 is the best assessment. The individual test criteria are each assessed individually.

The test criteria are: wet combability, wet feel, dry combability, dry feel, appearance/shine.

The results show that, surprisingly, the inventive compounds achieve better assessments than the comparative product “Quaternium-80”.

### Formulation as Hair Spray:

An inventive nitrogen-containing organosilicon graft copolymer was incorporated in a formulation for a non-aerosol hair spray with 80 mass % fraction of volatile organic compounds (so-called 80% VOC non-aerosol hair spray) according to the composition recited in the table which follows.

### Formulation of an 80% VOC Non-Aerosol Hair Spray

| | Fraction in % by |
|---|---|
| Component | weight |
| RESYN ® 28-2930 polymer | 5 |
| AMP ®-95 | 0.49 |
| Organosilicon graft copolymer | 4.5 |
| ABIL ® B 8843 | 0.2 |
| Deionized water | 13.81 |
| SD Alkohol 40 | 80 |

RESYN® 28-293 polymer: (INCI name: VA/Crotonates/Vinyl Neodecanoate Copolymer) is a product from National Starch.

AMP®-95: (INCI name: Aminomethyl Propanol) is a product from ANGUS Chemical Company.

ABIL® B 8843: (INCI name: PEG-14 Dimethicone) is a product from Evonik Goldschmidt GmbH.

SD Alkohol 40: ethanol.

The formulation from the table exhibited, following application as hair spray, an improved flexibility of the treated hair and produced a feel that was perceptibly better than that of a formulation that does not contain inventive organosilicon graft copolymer.

Formulation as Hair Styling Gel:

An inventive nitrogen-containing organosilicon graft copolymer was incorporated in a formulation for a hair styling gel according to the composition recited in the table below.

### Formulation of a Hair Styling Gel:

| | Fraction in % by |
|---|---|
| Component | weight |
| AMP ®-95 | 0.8 |
| Nitrogen-containing | 2 |
| organosilicon graft copolymer | |
| Deionized water | 86.4 |
| SD Alkohol 40 | 10 |
| Carbopol ® ETD 2020 | 0.8 |

AMP-95: (INCI name: Aminomethyl Propanol) is a product from Angus.

Carbopol ETD 2020: (INCI name: Acrylates/C10-30 Alkyl Acrylate Crosspolymer) is a product from Noveon.

The formulation forms a gel having a blancmange type consistency which, when applied as styling gel, leads to adequate stability in the hair coupled with simultaneous flexibility and pleasant feel.

### C) Use in Automotive Care

This invention further provides for the use of compounds according to the invention in commercial car washing in drying assistants in the car wash. The use of compounds according to the invention was tested in close to actual service formulations.

The following base recipe was tested:

| | |
|---|---|
| Butyldiglycol | 8.5% |
| Dipropylene glycol butyl ether | 5.5% |
| 9-Octadecenoic acid (Z)-, | 12.0% |
| reaction products with | |
| triethanolamine, quaternized | |
| with dimethyl sulphate | |
| Octyl palmitate | 5.0% |
| Acetic acid | 0.5% |
| Water ad 100 | |

The base recipe is formulation C1

### Formulation C2:

The base recipe with 0.8% of quaternary silicone compound as per patent EP 294643 (US RE 33956) as active ingredient is formulation C2.

### Formulation C3:

The base recipe with 0.8% of quaternary nitrogen-containing organosilicon graft copolymers as active ingredient is formulation C3.

These formulations were 1:1000 diluted with tap water in line with actual service and the dilutions were examined in respect of disruption.

The criterion for effective performance is the waterbreak on the car paintwork and also the glass surfaces of the vehicle following application of the drying assistant.

Whereas determination of waterbreak is difficult to reproduce on painted surfaces, glass surfaces are very suitable for this purpose.

The waterbreak behaviour was determined as follows:

The time needed to penetrate through a defined film of water on glass and to dewet the glass is measured. The first reaction time and also the complete displacement of the water on a microscope slide are noted.

Mirror tile

Microscope slide 76×26 mm (3×1 inch)

Pipette 3 ml plastic
Metering pipette 100 μl
Water of defined quality; conductivity value

### Stopwatch

Bunsen burner

Samples are measured as stated in water diluted form, usually in a 1:1000 dilution. The microscope slide is dedusted and briefly treated with an open flame to ensure am absolutely clean residueless surface.

0.5 ml of water is pipetted onto the microscope slide as a uniform film. If a film will not form, the microscope slide must be cleaned once more or discarded. Next 50 μl of the use dilution of the drying aid are applied centrally to the water surface and the stopwatch is started. The beginning of dewetting and the breaking of the retreating water on the 26 mm side are recorded. This makes it possible to determine the reaction time and the rate of waterbreaking. The time is reported in seconds.

Surprisingly, the formulations containing nitrogen-containing organosilicon graft copolymers achieve an appreciable shortening in the waterbreak time compared with quaternary silicone compounds known in the literature.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. Nitrogen-containing organosilicon graft copolymers obtained by a free-radical grafting step involving at least one ethylenically unsaturated monomer, wherein at least one monomer contains at least one quaternizable or quaternary nitrogen-containing functionality, in the presence of polyalkylene oxide containing siloxane derivatives free of ethylenically unsaturated groups.

2. Organosilicon graft copolymers according to claim 1, characterized in that the quaternizable or quaternary nitrogen-containing functionality is a cyclic or acyclic amine functionality.

3. Organosilicon graft copolymers according to claim 2, bearing at least one quaternary nitrogen functionality and obtainable by the free-radical graft polymerization of at least one ethylenically unsaturated monomer having at least one quaternary nitrogen-containing functionality in the presence of polyalkylene oxide containing siloxane derivatives.

4. Organosilicon graft copolymers according to claim 3, characterized in that the grafting base used comprises polyalkylene oxide containing polyether siloxanes of formula (I), 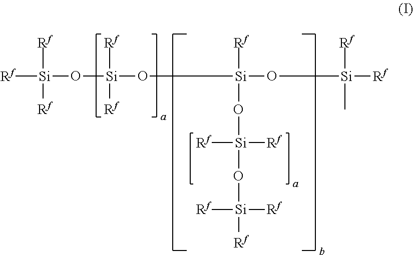
where
b is a number from 0 to 10,
a is a number from 1 to 500,
R^{f} in each occurrence is the same or different R¹ or R² provided that at least one R^{f} is R²,
R¹ represents organic radicals selected from linear or branched alkyl, haloalkyl, aryl, alkylaryl or arylalkyl radicals of 1 to 30 carbon atoms, wherein the radicals may optionally be interrupted by one or more oxygen and/or nitrogen atoms and/or may optionally have an —OC(O)CH₂ group at the end of the radical,
R² represents a group of the formula A_{α}-B_{β}—K_{χ}D_{δ}-E_{ε}-L_{λ}, where
α is 1,
β, χ, δ and ε is 0 or 1,
λ is 1 and
α+β+χ is ≧1, wherein
A is an oxygen atom or a CH₂ group,
B is a group of the general formula (II) 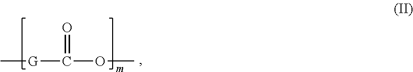
where
m is an integer from 0 to 30 and
G may be a divalent group selected from linear or branched, saturated alkyl, aryl, alkylaryl or arylalkyl groups of 1 to 20 carbon atoms,
K is a —CH₂— group or a divalent radical selected from linear or branched, saturated alkyl, aryl, alkylaryl or arylalkyl oxy groups of 1 to 20 carbon atoms or a group of the formula —CH₂—O—(CH₂)₄—O—,
D is a group of the general formula (III)
—(C₂H₄O)ₙ(C₃H₆O)ₚ(C₁₂H₂₄O)_{q}(C₈H₈O)ᵣ(C₄H₈O)ₛ—(III)
where the indices n, p, q, r and s are mutually independent integers from 0 to 100,
and where the sum total of n, p, q, r and s is 1,
and when more than one of the indices n, p, q, r, s is >0, the general formula (III) may be a random oligomer or a block oligomer,
E is a group of the general formula (IV) 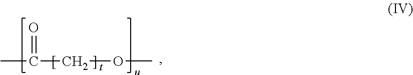
where
u is an integer from 0 to 5 and
t, when u is >0, may be the same or different and represents an integer 3, 4 or 5, and
L is selected from the group comprising hydrogen atoms, linear or branched, saturated alkyl, aryl, alkylaryl or arylalkyl groups of 1 to 12 carbon atoms, or acetoxy groups.

5. Organosilicon graft copolymers according to claim 4, characterized in that the grafting base used comprises polyether siloxanes of formula (I) where A=—H₂—, α=1, β=0, χ=1.

6. Organosilicon graft copolymers according to claim 5, characterized in that the grafting base used comprises polyether siloxanes of formula (I) where additionally K=—CH₂—CH₂—O—.

7. Organosilicon graft copolymers according to claim 1, characterized in that the unsaturated compound used for the graft polymerization comprises at least one monomeric, ethylenically unsaturated compound and polymeric olefins or macromonomers with at least one residue of unsaturatedness including those which contain siloxane chains and has at least one nitrogen-containing functionality which can be quaternized.

8. Organosilicon graft copolymers according to claim 7, characterized in that mixtures of nitrogen-containing and nitrogen-free monomers are graft polymerized.

9. Organosilicon graft copolymers according to claim 8, characterized in that in addition to at least one monomer having at least one nitrogen-containing functionality the graft polymerization utilizes a further unsaturated nitrogen-free compound comprising compounds of the general formula (VII) 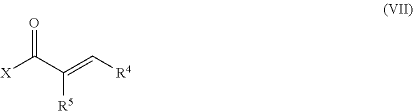
where R⁵ and R⁴ are independently selected from the group containing: —H, C₁-C₈ linear- or branched-chained alkyl chains, methoxy, ethoxy, 2-hydroxyethoxy, 2-methoxyethoxy and 2-ethoxyethyl,
X is selected from the group containing the radicals —OH, —OM, —OR⁶, NH₂, —NHR⁶, N(R⁶)₂, where the R⁶ radicals may be identical or different and are selected from the group consisting of —H, C₁-C₄₀ linear- or branched-chained alkyl radicals, N,N-dimethylaminoethyl, 2-hydroxyethyl, 2-methoxyethyl, 2-ethoxyethyl, hydroxypropyl, methoxypropyl or ethoxypropyl,
M is a cation selected from the group consisting of: Na⁺, K⁺, Mg⁺⁺, Ca⁺⁺, Zn⁺⁺, NH₄⁺, alkylammonium, dialkylammonium, trialkylammonium and tetraalkylammonium.

10. Organosilicon graft copolymers according to claim 1, characterized in that the nitrogen-containing monomers used comprise N,N-dialkylaminoalkyl acrylate and methacrylate and N-dialkylaminoalkylacrylamide and -methacrylamide of the general formula (VIII) 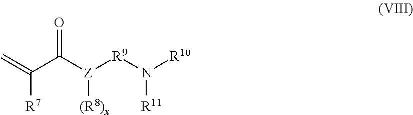
where R⁷=H, alkyl of 1 to 8 carbon atoms, R⁸=H, methyl, R⁹=alkylene of 1 to 24 carbon atoms, optionally substituted by alkyl, R¹⁰ and R¹¹ are each independently C₁-C₄₀ alkyl, Z=nitrogen for x=1 and oxygen for x=0, wherein the amides may be unsubstituted, N-alkyl or N-alkylamino monosubstituted or N,N-dialkyl substituted or N,N-dialkylamino disubstituted, wherein the alkyl or alkylamino groups are derived from C₁-C₄₀ linear, C₃-C₄₀ branched-chain or C₃-C₄₀ carbocyclic units.

11. Organosilicon graft copolymers according to claim 10, characterized in that the alkylamino groups are quaternized.

12. Organosilicon graft copolymers according to claim 11, characterized in that the nitrogen-containing monomers have at least one quaternary nitrogen-containing group and conform to the general formula (XI) 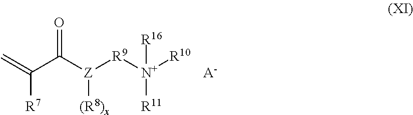
where R⁷, R⁸, R⁹, R¹⁰, R¹¹, Z and x are each as defined in formula (VIII), R¹⁶=C₁-C₄₀ alkyl and A⁻ is a suitable negatively charged anion selected from the group consisting of fluoride, chloride, bromide, iodide, alkylsulphates, methylsulphate or ethylsulphate, sulphate, hydrogensulphate, methanesulphonate and trifluoromethanesulphonate.

13. Organosilicon graft copolymers according to claim 12, characterized in that the compounds of formula (XI) comprise 2-trimethylammonioethyl methacrylate chloride, 2-trimethylammoniomethyl acrylate chloride, 2-triethylammonioethyl methacrylate chloride, 2-triethylammonioethyl acrylate chloride, 3-trimethylammoniopropylmethacrylamide chloride, 3-trimethylammoniopropylacrylamide chloride, 3-triethylammoniopropylmethacrylamide chloride and 3-triethylammoniopropylacrylamide chloride.

14. Compositions comprising graft copolymers according to claim 1.
